(19) United States
(12) Patent Application Publication
(10) Pub. No.: US 2017/0300857 A1
(43) Pub. Date: Oct. 19, 2017

(54) INSTANTANEOUS LOGISTICS ORDER PROCESSING SYSTEM

(71) Applicant: MITAC INTERNATIONAL CORP., Taoyuan City (TW)

(72) Inventors: Ying-Tz CHENG, Taoyuan City (TW); Yen-Cheng WU, Taoyuan City (TW)

(73) Assignee: MITAC INTERNATIONAL CORP., Taoyuan City (TW)

(21) Appl. No.: 15/483,473

(22) Filed: Apr. 10, 2017

(30) Foreign Application Priority Data
Apr. 18, 2016 (TW) 105111998

(51) Int. Cl. G06Q 10/08; G01C 21/34; H04L 29/08; H04W 88/02

(52) U.S. Cl. CPC G06Q 10/08355; H04L 67/02; G01C 21/343; H04W 88/02

(57) ABSTRACT

An instantaneous logistics order processing system, includes one or more sensor, configured to detect cargo information, the cargo information includes a current cargo weight of a logistics vehicle; a mobile communications apparatus, configured to calculate a remaining-load capacity; and a remote server, configured to receive an instantaneous logistics order and determine whether to transmit the instantaneous logistics order to the mobile communications apparatus, if the instantaneous logistics order matches an order-taking condition, the mobile communications apparatus asks a user whether to take the instantaneous logistics order; if the user takes the instantaneous logistics order, a navigation application program automatically changes an original navigation route to a changed navigation route, the changed navigation route includes a pickup location of the instantaneous logistics order, and a cargo weight of the instantaneous logistics order is deducted from the remaining-load capacity.

### CROSS-REFERENCE TO RELATED APPLICATION

This non-provisional application claims priority under 35 U.S.C. §119(a) to Patent Application No. 105111998 filed in Taiwan, R.O.C. on Apr. 18, 2016, the entire contents of which are hereby incorporated by reference.

### BACKGROUND

### Technical Field

The present invention relates to a logistics system, and in particular, to an instantaneous logistics order processing system.

### Related Art

Nowadays, on a real-time vehicle rental service platform or a real-time transport logistics service platform, when a driver takes an order, the driver cannot take another order before the current order is finished. However, in a logistics workflow, it is a pity that a loading truck cannot take another order and do more delivery if there still is enough loading space on the loading truck. Moreover, during the trip of delivery, how to enable a driver to choose to take an order or how to enable the driver to set a setting value of taking an order on the way is a problem that urgently needs to be resolved.

### SUMMARY

In view of the foregoing known technical problem, an objective of the present invention is to provide an instantaneous logistics order processing system, so that a loading truck or a logistics vehicle can perfectly use a remaining load weight or remaining load space to carry a cargo of another instantaneous logistics order by the way, so as to improve profitability, reduce costs, and accelerate an order-taking processing speed of an instantaneous logistics order.

According to the objective of the present invention, an instantaneous logistics order processing system is provided, including: a sensor, a mobile communications apparatus, and a remote server, where the sensor is configured to detect cargo information, where the cargo information includes a current cargo weight of a logistics vehicle; the mobile communications apparatus is configured to calculate a remaining-load capacity, according to a maximum load of the logistics vehicle, after obtaining the cargo information from the sensor; and the remote server is configured to: receive an instantaneous logistics order from the Internet, and determine, according to the remaining-load capacity provided by the mobile communications apparatus, whether to transmit the instantaneous logistics order to the mobile communications apparatus, where after the mobile communications apparatus receives the instantaneous logistics order transmitted by the remote server, the mobile communications apparatus asks a user whether to take the instantaneous logistics order when the instantaneous logistics order matches an order-taking condition; and when the user takes the instantaneous logistics order, a navigation application program of the mobile communications apparatus automatically changes an original navigation route to a changed navigation route, the changed navigation route includes a pickup location of the instantaneous logistics order, and the mobile communications apparatus deducts a cargo weight of the instantaneous logistics order from the remaining-load capacity.

Based on the foregoing conception, the mobile communications apparatus further provides a setting interface for the user to set the order-taking condition.

Based on the foregoing conception, the setting interface includes a distance setting option, for the user to set a predetermined distance, where if a distance between the pickup location of the instantaneous logistics order and any point of the original navigation route is shorter than the predetermined distance, it is determined that the instantaneous logistics order matches an order-taking condition.

Based on the foregoing conception, the setting interface includes a charging setting option, for the user to set a minimum charging fee, where if a shipping fee of the instantaneous logistics order is greater than the minimum charging fee, it is determined that the instantaneous logistics order matches an order-taking condition.

Based on the foregoing conception, the setting interface includes a cargo-delivery setting option, for the user to set a cargo-delivery condition, where if a delivered cargo of the instantaneous logistics order matches the cargo-delivery condition, it is determined that the instantaneous logistics order matches an order-taking condition.

Based on the foregoing conception, the setting interface includes a service content setting option, for the user to set a service content condition, where if service content of the instantaneous logistics order matches the service content condition, it is determined that the instantaneous logistics order matches an order-taking condition.

Based on the foregoing conception, the mobile communications apparatus asks, in a form of voice, the user whether to take the instantaneous logistics order.

Based on the foregoing conception, after asking the user whether to take the instantaneous logistics order, the mobile communications apparatus waits for a preset time, and if the user does not take the instantaneous logistics order in the preset time, the mobile communications apparatus sends an order-refused message to the remote server.

According to the objective of the present invention, an instantaneous logistics order processing system is further provided, including: at least one sensor, configured to detect cargo information, where the cargo information includes current loaded volume of a logistics vehicle; a mobile communications apparatus, configured to calculate a remaining-spare space, according to maximum load volume of the logistics vehicle, after obtaining the cargo information from the at least one sensor; and a remote server, configured to receive an instantaneous logistics order from the Internet, and determine whether to transmit the instantaneous logistics order to the mobile communications apparatus according to the remaining-spare space provided by the mobile communications apparatus, where after the mobile communications apparatus receives the instantaneous logistics order transmitted by the remote server, when the instantaneous logistics order matches an order-taking condition, the mobile communications apparatus asks a user whether to take the instantaneous logistics order; and when the user takes the instantaneous logistics order, a navigation application program of the mobile communications apparatus automatically changes an original navigation route to a changed navigation route, the changed navigation route includes a pickup location of the instantaneous logistics order, and the mobile communications apparatus deducts a cargo volume of the instantaneous logistics order from the remaining-spare space.

According to the objective of the present invention, an instantaneous logistics order processing system is further provided, including: a mobile communications apparatus, configured to provide a delivery space setting interface for the user to set remaining-spare space; and a remote server, configured to receive an instantaneous logistics order from the Internet, and determine whether to transmit the instantaneous logistics order to the mobile communications apparatus, according to the remaining-spare space provided by the mobile communications apparatus, where after the mobile communications apparatus receives the instantaneous logistics order transmitted by the remote server, when the instantaneous logistics order matches an order-taking condition, the mobile communications apparatus asks a user whether to take the instantaneous logistics order; and when the user takes the instantaneous logistics order, a navigation application program of the mobile communications apparatus automatically changes an original navigation route to a changed navigation route, the changed navigation route includes a pickup location of the instantaneous logistics order, and the mobile communications apparatus deducts a cargo volume of the instantaneous logistics order from the remaining-spare space.

### BRIEF DESCRIPTION OF THE DRAWINGS

The present invention will become more fully understood from the detailed description given herein below for illustration only, and thus are not limitative of the present invention, and where:

FIG. 1 is a flowchart of the present invention; and

FIG. 2 is a schematic diagram of a setting interface for setting an order-taking condition according to the present invention.

### DETAILED DESCRIPTION

A specific embodiment is given below to describe content of this solution in detail, and diagrams are used as auxiliary descriptions. For a symbol mentioned in the specification, refer to a schematic symbol. It should be noted that “include” mentioned in the specification is an open term, and should be understood as “include, but not limited to”. In addition, a person of ordinary skill in the art should know that one element/product usually has different names, for example “sensor” or “transducer”, and “mobile communications apparatus” or “portable communications apparatus”. Therefore, an element/product that is in the same field mentioned in this specification and that has a similar function should fall within the scope of this specification.

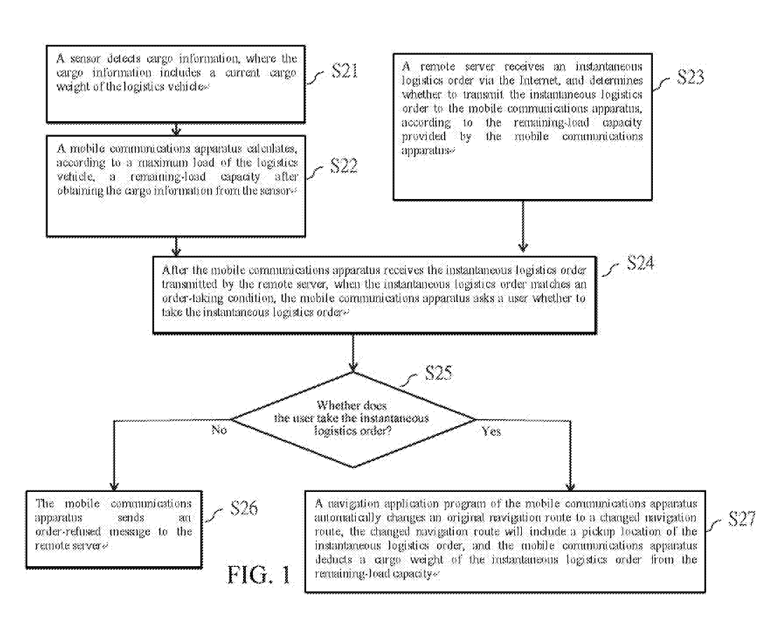

Referring to FIG. 1, FIG. 1 is flowchart of the present invention. Referring to step S21, a sensor installed in a logistics vehicle detects current cargo information of the vehicle, where the cargo information includes a current cargo weight of the logistics vehicle.

Referring to step S22, a mobile communications apparatus calculates, according to a maximum load of the logistics vehicle, a remaining-load capacity after obtaining the cargo information from the sensor. The maximum load may be preset by the user on a setting interface provided by the mobile communications apparatus, or may be acquired by the mobile communications apparatus from a remoted server or a particular website. The sensor may transmit the cargo information to the mobile communications apparatus via a wireless network, for example, the Bluetooth or the Wi-Fi protocol. The maximum load of the logistics vehicle and the remaining-load capacity is transmitted to a remote server for record via the Internet, by the mobile communications apparatus.

Referring to step S23, a remote server receives an instantaneous logistics order via the Internet, and determines whether to transmit the instantaneous logistics order to the mobile communications apparatus, according to the remaining-load capacity provided by the mobile communications apparatus. Generally speaking, an instantaneous logistics order is submitted by a customer on a particular website through a mobile apparatus or a computer device, and the customer is able to key in the delivery details/information on the particular website. The delivery details may include a weight of the cargo the customer would like to deliver. The remote server may determine whether a remaining-load capacity by the logistics vehicle is greater than the weight of the cargo, and if yes, determine to transmit the instantaneous logistics order to the mobile communications apparatus. It should be noted that in another embodiment, the mobile communications apparatus determines whether the remaining-load capacity by the logistics vehicle is greater than or equal to the weight of the cargo, and feedback the determination result to the remote server. The foregoing is merely an example, and it is not limited to the invention.

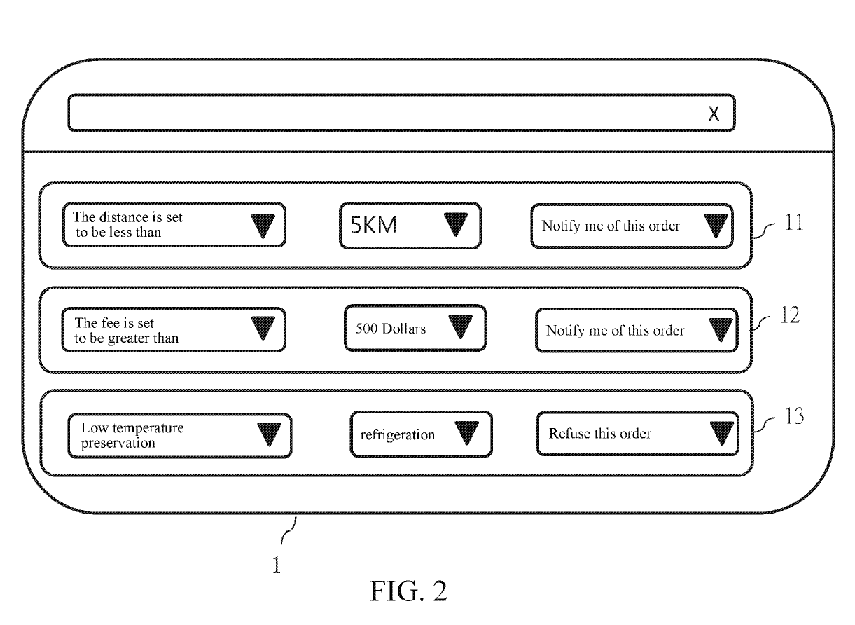

Referring to step S24, after the mobile communications apparatus receives the instantaneous logistics order transmitted by the remote server, when the instantaneous logistics order matches an order-taking condition, the mobile communications apparatus asks, in a form of voice, a user whether to take the instantaneous logistics order. Referring to FIG. 2, FIG. 2 is a schematic diagram of a setting interface for setting an order-taking condition according to the present invention. The mobile communications apparatus provides a setting interface 1 for the user to set the order-taking condition. In an embodiment, the setting interface includes a distance setting option 11, for the user to set a predetermined distance. If a distance between the pickup location of the instantaneous logistics order and any point of the original navigation route is shorter than the predetermined distance (which is 5 kilometers in an example of this diagram), it is determined that the instantaneous logistics order matches an order-taking condition, and then the operation shown on the rightmost of the distance setting option 11 is executed. In the example of this diagram, the instantaneous logistics order is transmitted by the remote server to the mobile communications apparatus, and the mobile communications apparatus asks the user whether to take the instantaneous logistics order. In another embodiment, the setting interface includes a charging setting option 12, for the user to set a minimum charging fee. If a shipping of the instantaneous logistics order is greater than the minimum charging fee (which is 500 Dollars in the example of this diagram), it is determined that the instantaneous logistics order matches an order-taking condition, and then the operation shown on the rightmost of charging setting option 12 is executed. In the example of this diagram, the instantaneous logistics order is transmitted by the remote server to the mobile communications apparatus, and the mobile communications apparatus asks the user whether to take the instantaneous logistics order. In another embodiment, the setting interface includes a cargo-delivery setting option 13, for the user to set a cargo-delivery condition (which is a cargo preserved in a low temperature in this embodiment). If a delivered cargo of the instantaneous logistics order matches the cargo-delivery condition, then the operation shown on the rightmost of the cargo-delivery setting option 13 is executed. In the example of this diagram, the mobile communications apparatus provides an order-refused message to the remote server (for example, the logistics vehicle does not have refrigeration system). In another embodiment, the setting interface includes a service content setting option (not shown in diagram), for the user to set a service content condition. If service content of the instantaneous logistics order matches the service content condition, for example, going upstairs or going downstairs or a foreign language service, operation shown on the rightmost of the service content setting option is executed. For example, this may be: the instantaneous logistics order is transmitted by the remote server to the mobile communications apparatus, and the mobile communications apparatus asks the user whether to take the instantaneous logistics order; or the mobile communications apparatus directly refuses the instantaneous logistics order, and the mobile communications apparatus sends an order-refused message for the remote server.

Referring to step S25, if the instantaneous logistics order is taken, step S27 is performed. If the instantaneous logistics order is not taken, step S26 is performed. In an implementation manner, after asking the user whether to take the instantaneous logistics order, the mobile communications apparatus waits for a preset time (for example, 5 seconds, this time period may be set on the setting interface). If the user does not take the instantaneous logistics order in the preset time, it is considered that the user refuse to take the instantaneous logistics order, and the mobile communications apparatus sends an order-refused message to the remote server.

Referring to step S26, in a scenario in which the user refuses to take the instantaneous logistics order, the mobile communications apparatus sends an order-refused message to the remote server.

Referring to step S27, in a scenario in which the user takes the instantaneous logistics order, a navigation application program of the mobile communications apparatus automatically changes an original navigation route to a changed navigation route, the changed navigation route will include a pickup location of the instantaneous logistics order, and the mobile communications apparatus deducts a cargo weight of the instantaneous logistics order from the remaining-load capacity.

Moreover, it should be noted that the above embodiment focuses on determining whether the remaining-load capacity is enough to take a weight of another cargo of the instantaneous logistics order. However, in another embodiment, current loaded volume may be detected by a space sensor. After obtaining the cargo information from the space sensor, the mobile communications apparatus calculates remaining-spare space according to maximum load space of the logistics vehicle; in other words, the mobile communications apparatus evaluates whether a cargo volume, instead of the weight, of the instantaneous logistics order can be taken, by using the remaining-spare space. The foregoing space or weight is merely used as an example but not a limitation to the invention. In the embodiment regarding the remaining-spare space, the mobile communications apparatus may provide a delivery space setting interface, where the delivery space setting interface may be used by the user to set remaining-spare space. If the user takes the instantaneous logistics order, a navigation application program of the mobile communications apparatus automatically changes the original navigation route to the changed navigation route, the changed navigation route will include the pickup location of the instantaneous logistics order, and the mobile communications apparatus deducts the cargo volume of the instantaneous logistics order from the remaining-spare space.

In conclusion, with the instantaneous logistics order processing system of the present invention, load space or a load capacity of logistics vehicle may be fully used. Therefore, even though a driver has taken an order, the driver still can take another order for a delivery during the trip of the taken order by keeping calculating a remaining-spare space or a remaining-load capacity. In addition, the present invention also completely describes how to design an interface for setting an order-taking condition and an operation procedure to match a driver's preference.

The foregoing is merely used as an example, but not a limitation. Any equivalent modification or change made on the present invention without departing from the spirit and scope of the present invention shall fall within the scope of this application.

What is claimed is:

1. An instantaneous logistics order processing system, comprising:
at least one sensor, configured to detect cargo information, wherein the cargo information comprises a current cargo weight of a logistics vehicle;
a mobile communications apparatus, configured to calculate a remaining-load capacity according to a maximum load of the logistics vehicle, after obtaining the cargo information from the sensor; and
a remote server, configured to receive an instantaneous logistics order from the Internet, and determine whether to transmit the instantaneous logistics order to the mobile communications apparatus, according to the remaining-load capacity provided by the mobile communications apparatus, wherein
after the mobile communications apparatus receives the instantaneous logistics order transmitted by the remote server, the mobile communications apparatus asks a user whether to take the instantaneous logistics order when the instantaneous logistics order matches an order-taking condition; and
when the user takes the instantaneous logistics order, a navigation application program of the mobile communications apparatus automatically changes an original navigation route to a changed navigation route, the changed navigation route comprises a pickup location of the instantaneous logistics order, and the mobile communications apparatus deducts a cargo weight of the instantaneous logistics order from the remaining-load capacity.

2. The instantaneous logistics order processing system according to claim 1, wherein
the mobile communications apparatus provides a setting interface for the user to set the order-taking condition.

3. The instantaneous logistics order processing system according to claim 2, wherein
the setting interface comprises a distance setting option, for the user to set a predetermined distance, wherein
if a distance between the pickup location of the instantaneous logistics order and any point of the original navigation route is shorter than the predetermined distance, it is determined that the instantaneous logistics order matches the order-taking condition.

4. The instantaneous logistics order processing system according to claim 2, wherein
the setting interface comprises a charging setting option, for the user to set a minimum charging fee, wherein
if a shipping fee of the instantaneous logistics order is greater than the minimum charging fee, it is determined that the instantaneous logistics order matches an order-taking condition.

5. The instantaneous logistics order processing system according to claim 2, wherein
the setting interface comprises a cargo-delivery setting option, for the user to set a cargo-delivery condition, wherein
if a delivered cargo of the instantaneous logistics order matches the cargo-delivery condition, it is determined that the instantaneous logistics order matches an order-taking condition.

6. The instantaneous logistics order processing system according to claim 2, wherein
the setting interface comprises a service content setting option, for the user to set a service content condition, wherein
if service content of the instantaneous logistics order matches the service content condition, it is determined that the instantaneous logistics order matches an order-taking condition.

7. The instantaneous logistics order processing system according to claim 1, wherein
the mobile communications apparatus asks, in a form of voice, the user whether to take the instantaneous logistics order.

8. The instantaneous logistics order processing system according to claim 1, wherein
after asking the user whether to take the instantaneous logistics order, the mobile communications apparatus waits for a preset time, and if the user does not take the instantaneous logistics order in the preset time, the mobile communications apparatus sends an order-refused message to the remote server.

9. An instantaneous logistics order processing system, comprising:
at least one sensor, configured to detect cargo information, wherein the cargo information comprises current loaded volume of a logistics vehicle;
a mobile communications apparatus, configured to calculate a remaining-spare space, according to maximum load volume of the logistics vehicle, after obtaining the cargo information from the sensor; and
a remote server, configured to receive an instantaneous logistics order from the Internet, and determine whether to transmit the instantaneous logistics order to the mobile communications apparatus, according to the remaining-spare space provided by the mobile communications apparatus, wherein
after the mobile communications apparatus receives the instantaneous logistics order transmitted by the remote server, the mobile communications apparatus asks a user whether to take the instantaneous logistics order when the instantaneous logistics order matches an order-taking condition; and
when the user takes the instantaneous logistics order, a navigation application program of the mobile communications apparatus automatically changes an original navigation route to a changed navigation route the changed navigation route comprises a pickup location of the instantaneous logistics order, and the mobile communications apparatus deducts a cargo volume of the instantaneous logistics order from the remaining-spare space.

10. An instantaneous logistics order processing system, comprising:
a mobile communications apparatus, configured to provide a delivery space setting interface for a user to set remaining-spare space; and
a remote server, configured to receive an instantaneous logistics order from the Internet, and determine whether to transmit the instantaneous logistics order to the mobile communications apparatus, according to the remaining-spare space provided by the mobile communications apparatus, wherein
after the mobile communications apparatus receives the instantaneous logistics order transmitted by the remote server, the mobile communications apparatus asks a user whether to take the instantaneous logistics order when the instantaneous logistics order matches an order-taking condition; and
when the user takes the instantaneous logistics order, a navigation application program of the mobile communications apparatus automatically changes an original navigation route to a changed navigation route the changed navigation route comprises a pickup location of the instantaneous logistics order, and the mobile communications apparatus deducts a cargo volume of the instantaneous logistics order from the remaining-spare space.
